(19) United States
(12) Patent Application Publication
(10) Pub. No.: US 2010/0194362 A1
(43) Pub. Date: Aug. 5, 2010

(54) REGULATOR WITH PULSE WIDTH MODULATION CIRCUIT

(75) Inventor: Kanji EGAWA, Sendai (JP)

Correspondence Address: ONDA TECHNO Intl. Patent Attys., 12-1 Omiya-cho 2-chome, Gifu City, 500-8731, JP

(73) Assignee: FREESCALE SEMICONDUCTOR, INC., Austin, TX (US)

(21) Appl. No.: 12/617,732

(22) Filed: Nov. 13, 2009

(30) Foreign Application Priority Data
Feb. 5, 2009 (JP) 2009-024785

(51) Int. Cl. G05F 1/10

(52) U.S. Cl. 323/282

(57) ABSTRACT

A pulse width modulation circuit that controls the output voltage of a regulator. The regulator includes a switching element, which is activated and deactivated by a pulse signal, and a PMW control circuit, which provides the switching element with the pulse signal in accordance with a duty ratio determined from a reference voltage and an error voltage. The error voltage is the difference between the output voltage and reference voltage. The PWM control circuit includes a current source that generates a current in accordance with the error voltage, a capacitor arranged between the current source and ground, and a comparator. The comparator has a non-inverting input terminal, which is connected between the current source and capacitor, and an inverting input terminal, to which the reference voltage is applied. An output signal of the comparator is provided to the switching element.

### BACKGROUND OF THE INVENTION

The present invention relates to a pulse width modulation (PWM) circuit for use in a regulator, a pulse modulation method, and a regulator having a PWM circuit.

A regulator including a switching element is used as a power supply device that generates a desired output voltage from an input voltage. Examples of such a regulator include a buck regulator, which has an output voltage that is lower than its input voltage, and a boost regulator, which has an output voltage that is higher than its input voltage (refer to, for example, Japanese Laid-Open Patent Publication No. 2006-238640, page 1 and FIG. 6). There is also a buck-boost regulator, which has an output voltage that may be set in a range lower than to higher than its input voltage (refer to, for example, Japanese Laid-Open Patent Publication No. 2005-110468, page 1 and FIGS. 1 and 2). The buck-boost regulator of Japanese Laid-Open Patent Publication No. 2005-110468 includes a plurality of phased compensation circuits to stabilize its output. The phase compensation circuits are switch when raising or lowering the voltage the voltage.

The boost regulator described in Japanese Laid-Open Patent Publication No. 2006-238640 includes a PWM circuit that adjusts the duty ratio to control the switching element. The boost regulator also includes a feedback element to stabilize its output. The feedback element includes an error comparator and the PWM circuit. The error comparator compares the output voltage with a reference voltage and outputs a signal having an error voltage Verr (error signal). The PWM circuit uses the error signal and the reference voltage to adjust the duty ratio.

A pulse width modulation circuit 50, which is used as a boost regulator, will now be discussed with reference to FIG. 4A. The pulse width modulation circuit 50 includes a current source 51, a capacitor 52, a transistor 53, and a comparator 55. The current source 51, which generates a current I1 in accordance with a reference voltage Vref, is connected to the capacitor 52. The transistor 53 is connected in parallel to the capacitor 52. A connection node between the current source 51 and the capacitor 52 is connected to an inverting input terminal of the comparator 55. An error voltage Verr is applied to the non-inverting input terminal of the comparator 55. The comparator 55 compares the error voltage Verr with a charge voltage V1 generated at the connection node between the current source and the capacitor 52 to output a pulse signal S1 in accordance with the comparison result.

More specifically, when the transistor 53 is deactivated, current flows from the current source 51 to the capacitor 52 thereby charging the capacitor 52. In this case, referring to FIG. 4B, the charge voltage V1 at the connection node between the current source 51 and capacitor 52 increases proportionally. The comparator 55 provides the switching element with a pulse signal having a high level when the charge voltage V1 is less than or equal to the error voltage Verr and a pulse signal having a low level when the charge voltage V1 is greater than the error voltage Verr. The switching element is deactivated when the pulse signal has a low level and activated when the pulse signal has a high level. The capacitor 52 is discharged when the transistor 53 is activated by a clock signal CL1 applied to its gate. As a result, the charge voltage V1 becomes zero volts (0 V).

As described above, the boost regulator controls the switching element in accordance with the output voltage Vout to keep the output voltage Vout constant. The output voltage Vout of the boost regulator is thus expressed using the input voltage by equation (1).

Vout=Vin/(1−D) (1)

Here, D represents the duty ratio of the pulse signal. In the pulse width modulation circuit 50 of FIG. 4A, D corresponds to the duty ratio D1, which is shown in FIG. 4B. The duty radio D1 of the pulse width modulation circuit 50 may be expressed by Verr/Vref. Thus, when substituting the equation of duty ratio D1=Verr/Vref for D in equation (1), the following equation (2) is obtained.

Vout=Vin/(1−Verr/Vref) (2)

It may be understood from equation (2) that the output voltage Vout varies non-linearly in accordance with the error voltage Verr. It is thus difficult to control the output voltage Vout with the error voltage Verr.

### BRIEF DESCRIPTION OF THE DRAWINGS

The present invention is illustrated by way of example and is not limited by the accompanying figures, in which like references indicate similar elements. Elements in the figures are illustrated for simplicity and clarity and have not necessarily been drawn to scale.

FIG. 1 is a circuit diagram of a regulator according to one embodiment of the present invention;

FIG. 2 is a circuit diagram of a pulse width modulation circuit shown in FIG. 1;

FIG. 3A is a graph showing changes in the charge voltage V1 in the pulse width modulation circuit of FIG. 2 when the error voltage Verr is constant;

FIG. 3B is a graph showing changes in the charge voltage V1 in the pulse width modulation circuit of FIG. 2 when the error voltage Verr is varied;

FIG. 4A is a circuit diagram of a pulse width modulation circuit in a regulator of the prior art; and

FIG. 4B is a graph showing changes in the charge voltage V1 for the regulator shown in FIG. 4A when the error voltage Verr is constant.

### DETAILED DESCRIPTION OF THE INVENTION

The present invention provides a pulse width modulation circuit and a pulse width modulation method that linearly control the output voltage of a regulator relative to an error voltage and provides a regulator having an easily controllable output voltage.

One aspect of the present invention is a pulse width modulation circuit including a switching element activated and deactivated in accordance with a duty ratio of a pulse signal. A pulse width control circuit provides the pulse signal to a regulator that outputs an output voltage greater than an input voltage. The pulse width control circuit includes a current source that generates current in accordance with an error voltage. The error voltage is the difference between the output voltage and a reference voltage of the regulator. A capacitor is connected to the current source. A comparator outputs the pulse signal to the switching element and has an inverting input terminal to which the reference voltage is applied and a non-inverting input terminal to which voltage at a connection node between the current source and capacitor is applied.

A further aspect of the present invention is a method of modulating the pulse width of a pulse signal. The pulse signal is provided to a switching element of a regulator. The regulator outputs an output voltage greater than its input voltage. The switching element is activated when the pulse signal has a high level and deactivated when the pulse signal has a low level. The pulse signal has a duty ratio determined by a reference voltage and an error voltage, which is in accordance with the output voltage of the regulator and the reference voltage. The method includes outputting the pulse signal at a low level when a charge voltage of a capacitor, which is supplied with current that is in accordance with the error voltage, is less than or equal to the reference voltage, and at a high level when the charge voltage is greater than the reference voltage.

Yet another aspect of the present invention is a regulator including an inductor and a rectifying element connected in series between an input terminal and an output terminal. A capacitor is connected to a cathode of the rectifying element. A switching element is activated and deactivated in accordance with a duty ratio of a pulse signal. The switching element is connected to a connection node between the inductor and the rectifying element. A pulse width modulation circuit provides the switching element with the pulse signal. The pulse width modulation circuit includes a current source that generates current in accordance with an error voltage, which is the difference of an output voltage and reference voltage of the regulator. A capacitor is connected to the current source. A comparator outputs the pulse signal. The comparator has an inverting input terminal to which the reference voltage is applied and a non-inverting input terminal to which voltage at a connection node between the current source and capacitor is applied.

Other aspects and advantages of the present invention will become apparent from the following description, taken in conjunction with the accompanying drawings, illustrating by way of example the principles of the invention.

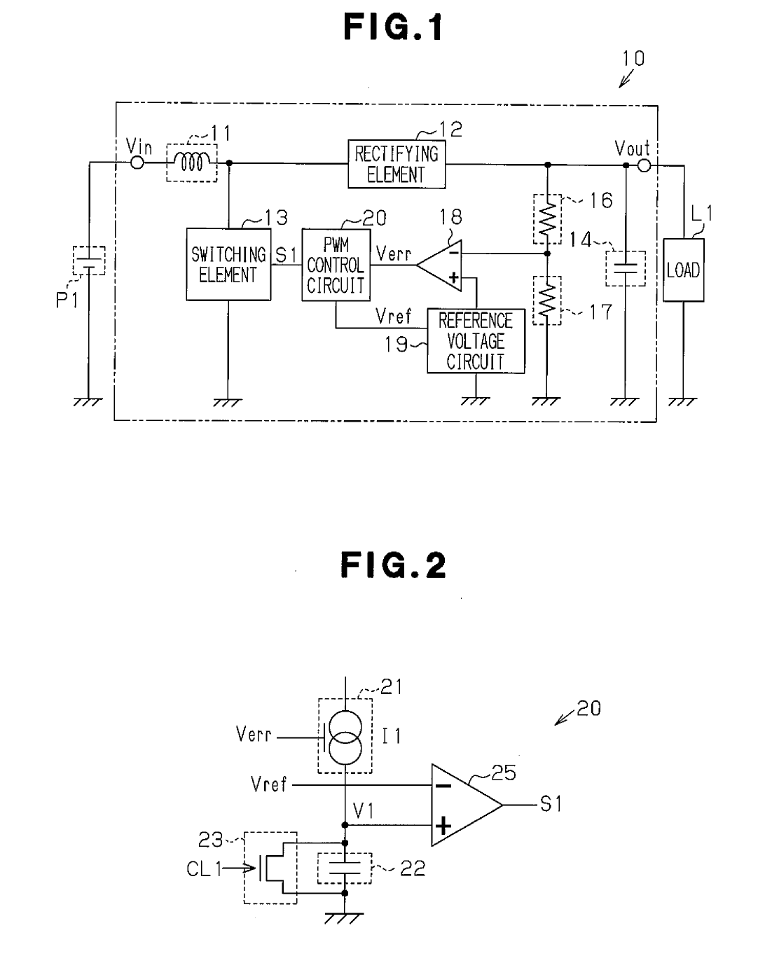

A regulator 10 and a power width modulation (PWM) control circuit 20 of the regulator 10 according to one embodiment of the present invention will now be discussed with reference to FIGS. 1 to 3. The regulator 10 will first be described with reference to FIG. 1.

The regulator 10 has an input terminal connected to an input power supply P1, which supplies an input voltage Vin to the regulator 10. The regulator 10 also has an output terminal, which an output voltage Vout to a load L1 that is connected to the regulator.

The regulator 10 includes an inductor 11, a rectifying element 12, a switching element 13, and a capacitor 14, in addition to the PWM control circuit 20. The inductor 11 and the rectifying element 12 are connected in series between the input terminal and output terminal of the regulator 10. The switching element 13 is connected between ground and a connection node between the inductor 11 and rectifying element 12. The switching element 13 is activated and deactivated in accordance with a pulse signal S1 provided from the PWM control circuit 20. The capacitor 14 is connected between ground and a connection node between the rectifying element 12 and the regulator output terminal.

Resistors 16 and 17 are connected in series between ground and the connection node between the output terminal and the rectifying element 12. A node between the resistors 16 and 17 is connected to an error comparator 18.

A reference voltage circuit 19 generates a reference voltage Vref. The reference voltage Vref is supplied to a non-inverting input terminal of the error comparator 18 and the PWM control circuit 20. In the present embodiment, the reference voltage generated by the reference voltage circuit 19 is proportional to the input voltage Vin.

The error comparator 18 has a non-inverting input terminal connected to the reference voltage circuit 19 and receiving the reference voltage Vref, an inverting input terminal that is connected to the node between the resistors and 17 and receives the output voltage Vout, and an output terminal connected to the PWM control circuit 20. The error comparator 18 compares the output voltage Vout and the reference voltage Vref, and outputs an error voltage Verr that is in accordance with a difference between the compared voltages Vout and Vref.

The PWM control circuit 20 will now be discussed with reference to FIG. 2. In the present embodiment, the PWM control circuit 20 includes a current source 21, a capacitor 22, a transistor 23, and a comparator 25.

The current source 21 supplies a current to the capacitor 22. In the present embodiment, the current source supplies a current I1, wherein the current I1 is proportional to the error voltage Verr generated by the error comparator 18.

The capacitor 22 has one terminal connected to the current source 21 and another terminal connected to ground. The transistor 23 is connected to the two terminals of the capacitor 22. More specifically, in one embodiment, the transistor 23 is an NMOS transistor and has a gate terminal provided with a clock signal CL1. Thus, when the transistor 23 is activated by the clock signal CL1, the capacitor 22 is discharged by way of the transistor 23. When the transistor is deactivated, the capacitor 22 is charged by the current source 21.

A non-inverting input terminal of the comparator 25 is connected to a node between the current source 21 and the capacitor 22. In FIG. 2, the voltage at this connection node is expressed as charge voltage V1. The reference voltage Vref is applied to an inverting input terminal of the comparator 25. The comparator 25 compares the charge voltage V1 with the reference voltage Vref, and outputs the pulse signal S1. The pulse signal S1 is low when the charge voltage V1 is less than the reference voltage Vref, and high when the charge voltage V1 is greater than the reference voltage Vref. The pulse signal S1 generated by the comparator 25 is provided to the switching element 13 (FIG. 1) as an output signal of the PWM control circuit 20. The switching element 13, which is provided with the pulse signal S1, is deactivated when the pulse signal S1 is low and activated when the pulse signal S1 is high.

The operation of the regulator 10 will now be discussed. When the switching element 13 is activated, current from the input power supply P1 flows via the switching element 13 to ground. In this case, in the rectifying element 12, the voltage at the anode becomes less than the voltage at the cathode. This deactivates the rectifying element 12 and the charge stored in the capacitor 14 is supplied to the load L1.

Subsequently, when the switching element 13 is deactivated, the flow of current through it is stopped. Thus, the inductor 11 generates a counter electromotive force (EMF). The counter EMF activates the rectifying element 12 and is transmitted to the capacitor 14 and load L1 via the rectifying element 12. Thus, the output voltage Vout output by the regulator 10 is greater than the input voltage Vin.

The error comparator 18, which serves as a feedback element, constantly supplies the PWM control circuit 20 with the error voltage Verr in accordance with the difference between a divisional voltage of the output voltage Vout and the reference voltage Vref.

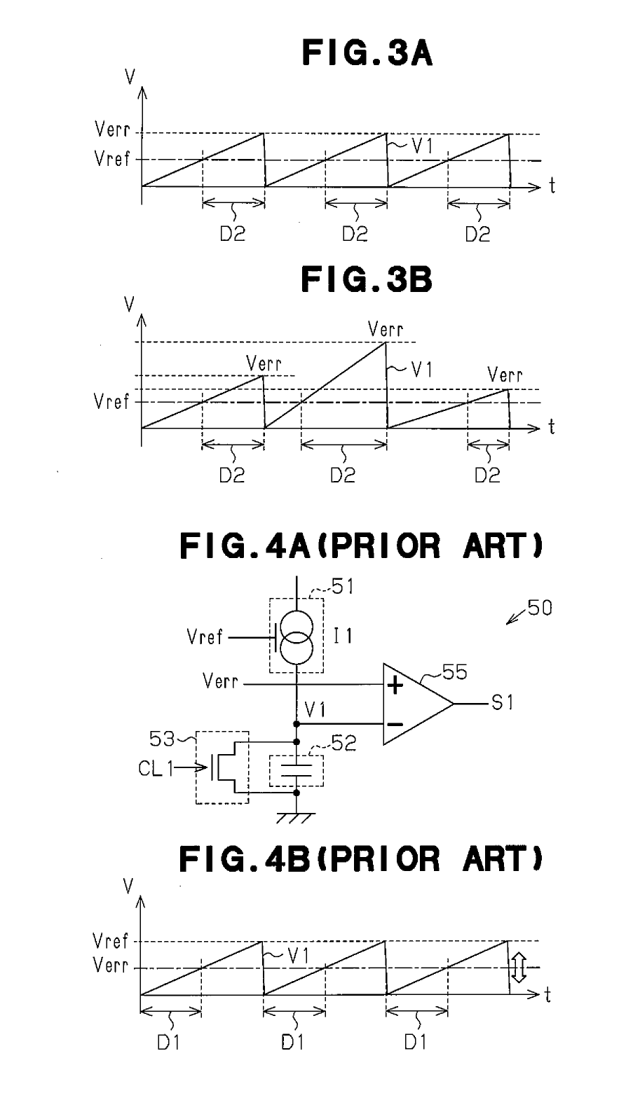

Referring to FIG. 3A, when the clock signal CL1 is provided to the PWM control circuit 20, the transistor 23 is activated, the capacitor 22 is discharged, and the charge voltage V1 goes to zero volts (0 V). When the clock signal CL1 is not provided, the transistor 23 is deactivated. In this case, the capacitor 22 is supplied with current from the current source 21, and the charge voltage V1 gradually increases from 0 V. The current source 21 outputs a constant current I1 when the error voltage Verr is constant. This charges the capacitor 22 in proportion to time and thereby increases the charge voltage V1 in proportion to time.

In this state, the comparator 25 shifts the pulse signal S1 to a low level when the charge voltage V1 is less than or equal to the reference voltage Vref, and the comparator 25 shifts the pulse signal S1 to a high level when the charge voltage V1 is greater than the reference voltage Vref. The switching element 13 is activated or deactivated depending on whether the pulse signal S1 is high or low.

The transfer function of the regulator 10 will now be discussed. In the PWM control circuit 20 of the present embodiment, as shown in FIG. 3B, the current I1 is output in accordance with the level of the charge voltage V1. Thus, during the period from when a clock signal CL1 is obtained to when the next clock signal CL1 is obtained, the charge voltage V1 rises from 0 V to the level of the error voltage Verr. In this case, the reference voltage Vref supplied to the comparator 25 is constant. Here, a duty ratio D2 is expressed by equation (3).

1−D2=Vref/Verr (3)

Further, when substituting the duty ratio D2 in equation (3) for D in equation (1), which expresses the output voltage Vout of the regulator 10, the following equation (4) is obtained.

Vout=Vin×Verr/Vref (4)

When using the expression of α=Vin/Vref, the expression of Vout=α×Verr is obtained. That is, if the input voltage Vin and the reference voltage Vref are constant, the output voltage Vout varies proportionally (linearly) in accordance with the error voltage Verr.

The above-described embodiment has the advantages described below.

In the above-described embodiment, the PWM control circuit 20 of the regulator 10 includes the current source 21 and the comparator 25. The current source 21 generates current I1 in accordance with the level of the error voltage Verr. In the comparator 25, the reference voltage Vref is supplied to the inverting input terminal, and the charge voltage V1 at the node between the current source 21 and the capacitor 22 is supplied to the non-inverting input terminal. Thus, the PWM control circuit 20 outputs a pulse signal having a low level when the charge voltage V1 of the capacitor 22, which is supplied with current I1 that is in accordance with the level of the error voltage Verr, is less than or equal to the reference voltage Vref. Further, the PWM control circuit 20 outputs a pulse signal having a high level when the charge voltage V1 of the capacitor 22 is greater than the reference voltage Vref. In this case, the pulse signal S1 is output with duty ratio D2, in which a value obtained by subtracting the duty ratio D2 from 1 is proportional to an inverse of the error voltage Verr. Accordingly, when controlling the switching element 13 with the pulse signal S1 output from the regulator 10, the output voltage Vout of the regulator 10 is a value proportional to the error voltage Verr. This facilitates control that is in accordance with the level of the error voltage Verr and stabilizes the output of the regulator 10.

In the above-described embodiment, the reference voltage circuit 19 generates the reference voltage Vref in proportion to the input voltage Vin of the regulator 10. In this case, as apparent from equation (4), the output voltage Vout is not dependent on the input voltage Vin. Thus, the output voltage Vout of the regulator 10 is unaffected by changes in the input voltage Vin. This further stabilizes the output of the regulator 10.

It should be apparent to those skilled in the art that the present invention may be embodied in many other specific forms without departing from the spirit or scope of the invention. Particularly, it should be understood that the present invention may be embodied in the following forms.

In the comparator 25 of the PWM control circuit 20 in the above-described embodiment, the reference voltage Vref is supplied to the inverting input terminal, and the charge voltage V1 at the node between the current source 21 and capacitor 22 is supplied to the non-inverting input terminal. However, the present invention is not limited to such a configuration as long as the PWM control circuit 20 outputs a low pulse signal when the charge voltage V1 at the capacitor 22, which is supplied with current I1 that is in accordance with the level of the error voltage Verr, is less than or equal to the reference voltage Vref, and the PWM control circuit 20 outputs a high pulse signal when the charge voltage V1 is greater than the reference voltage Vref. For example, instead of the comparator 25, a comparator used in combination with an inverter may be employed. In such a case, the comparator has a non-inverting input terminal supplied with reference voltage Vref and an inverting input terminal supplied with the charge voltage V1 from the node between the current source 21 and the capacitor 22. The comparator also has an output terminal connected to an input terminal of the inverter. The pulse signal output from the inverter is provided to the switching element 13. In this case as well, the output voltage Vout of the regulator is controlled linearly in accordance with the error voltage Verr of the regulator output voltage Vout.

In the above-described embodiment, the regulator 10, which outputs a higher voltage than its input voltage, uses the PWM control circuit 20. The PWM control circuit 20 of the present invention is not limited in such a manner and a buck-boost regulator, which outputs voltage set in a range lower than to higher than its input voltage, may be used. In such a case, when outputting voltage that is lower than the input voltage (when lowering the voltage), the linear pulse width modulation circuit 50 of the prior art is used. When outputting voltage that is greater than the input voltage, the voltages supplied to the comparator 25 (i.e., reference voltage Vref and charge voltage V1) and the error voltage Verr supplied to the current source 21 are changed so as to form the PWM control circuit 20 of the present invention. As a result, even when outputting voltage set in a range lower than to higher than the input voltage, the output voltage of the regulator may be further stabilized.

The regulator 10 of the above-described embodiment includes the reference voltage circuit 19. However, the present invention is not limited in such a manner, and the regulator does not have to include a reference voltage circuit as long as the PWM control circuit 20 is supplied with the error voltage Verr and the reference voltage Vref.

The present examples and embodiments are to be considered as illustrative and not restrictive, and the invention is not to be limited to the details given herein, but may be modified within the scope and equivalence of the appended claims.

1. A pulse width modulation circuit, comprising:
a switching element activated and deactivated in accordance with a duty ratio of a pulse signal;
a pulse width control circuit that provides the pulse signal to the switching element, wherein the switching element is part of a regulator, wherein the regulator outputs an output voltage greater than an input voltage, the pulse width control circuit including:
a current source that generates a current in accordance with an error voltage, wherein the error voltage is the difference of the output voltage and a reference voltage of the regulator;
a capacitor connected in series with the current source; and
a comparator that outputs the pulse signal to the switching element, wherein the comparator has an inverting input terminal that receives the reference voltage and a non-inverting input terminal to which voltage at a connection node between the current source and capacitor is applied.

2. The pulse width modulation circuit of claim 1, wherein the reference voltage is proportional to the input voltage of the regulator.

3. A method of modulating a pulse width of a pulse signal that is output to a switching element of a regulator, wherein the regulator outputs an output voltage greater than its input voltage, the switching element being activated when the pulse signal has a high level and deactivated when the pulse signal has a low level, the pulse signal having a duty ratio determined by a reference voltage and an error voltage, which is in accordance with the output voltage of the regulator and the reference voltage, the method comprising:
outputting the pulse signal at a low level when a charge voltage of a capacitor, which is supplied with current that is in accordance with the error voltage, is less than or equal to the reference voltage; and
outputting the pulse signal at a high level when the charge voltage is greater than the reference voltage.

4. A regulator comprising:
an inductor and a rectifying element connected in series between an input terminal and an output terminal;
a first capacitor connected to a cathode of the rectifying element;
a switching element activated and deactivated in accordance with a duty ratio of a pulse signal, wherein the switching element is connected to a node between the inductor and the rectifying element; and
a pulse width modulation circuit that provides the switching element with the pulse signal, the pulse width modulation circuit including:
a current source that generates a current in accordance with an error voltage, wherein the error voltage is the difference between an output voltage and a reference voltage of the regulator;
a second capacitor connected to the current source; and
a comparator that outputs the pulse signal to the switching element, wherein the comparator has an inverting input terminal to which the reference voltage is applied and a non-inverting input terminal to which voltage at a node between the current source and the second capacitor is applied.

5. The regulator of claim 4, wherein the reference voltage is proportional to the input voltage of the regulator.

6. The pulse width modulation circuit of claim 1, further comprising a transistor connected in parallel with the capacitor, wherein a clock signal is applied to a gate of the transistor.

7. The pulse width modulation circuit of claim 4, further comprising a transistor connected in parallel with the second capacitor, wherein a clock signal is applied to a gate of the transistor.
